(19) United States
(12) Patent Application Publication
(10) Pub. No.: US 2006/0123778 A1
(43) Pub. Date: Jun. 15, 2006

(54) Engine for generating mechanical energy

(76) Inventor: Cong Nhan Huynh, Ho Chi Minh City (VN)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/532,243

(22) PCT Filed: Oct. 20, 2003
(86) PCT No.: PCT/VN03/00004

§ 371 Date: Apr. 22, 2005

(30) Foreign Application Priority Data
Oct. 22, 2002 (VN) 1-2002-00964

(51) Int. Cl. F02G 1/04

(52) U.S. Cl. 60/508

(57) ABSTRACT

This invention relates to the production of engines based on a new physical principle in which the engines will extremely quickly change the physical state of fluids or solids, especially the substances with low boiling points such as liquid water, liquid nitrogen, CO2 powder, in which the outputted mechanical energy is significantly greater than the inputted energy to operate the engine. The engine is called engine for dispersing matter into the surrounding space in order to produce mechanical energy, or in short, matter-dispersing engine.

### FIELD OF INVENTION

This invention relates to engines based on the new physical principle according to which an engine in operation will disperse at high speed matter in the surrounding space; it especially will disperse, or change the physical states of such low-boiling-point substances as fluid water, fluid nitrogen, CO₂ powder from a high density to a low density (into the atmosphere or the outer space) so as to generate mechanical energy that is much greater than the amount of inputted heat energy to operate the engine.

The invention also relies on the concept of the extra-fast change of physical states of products resulting from the reaction between fuel and oxidant from a high density to a low density to produce jet-thrust engines with powerful mechanical energy and explosion engines which generate great amounts of mechanical energy with low consumption of fuel.

### BACKGROUND OF THE INVENTION

So far the production of energy by means of fission or nuclear fusion methods are the only methods that can produce huge amounts of energy from small amounts of fuel input. However, nuclear energy production by fission presents different hazards to the environment such as leaks of radioactivity and radioactive waste—the disposal or long-term isolation of the latter for a is still an unsolved problem. The production of nuclear energy by fusion requires the reaction to be maintained at a temperature of 10⁶ degrees Celsius; this technology is still out of reach of present technology. The other methods of production of clean energy such as wind energy, solar energy, hydro energy have their disadvantages and limitations in that the apparatus thereof is disposed over large areas but generates comparatively little power; geothermal and hydroelectric power plants can only be built in few places; ocean thermal energy has an unlimited source but is still in the research stage.

Most of the energy is currently produced by burning fossil fuels of which the supply will last for a short time. The immoderate exploitation and burning of fossil fuels have significantly affected the ecology of living creatures on the earth. Furthermore, methods of generation of energy are performed based on principle: the output energy is much smaller than the input energy. Efficiency rates of different types of heat engines are respectively: 15% for steam engines, 28% for gasoline engines, 37% for diesel engines, 85% for electric engines. Typical examples of heat engines are:

The steam engine invented by J. Watt in 1769 which operates like this: water is changed into steam at high saturation vapor pressure, this steam then flows into a chamber in which a piston going up and down can change the volume of the chamber; the steam expands and generates mechanical power then condenses and decreases the volume of the chamber, returning everything to the starting point for the next cycle.

The internal-combustion engine developed by N. Otto in 1879 which operates like this: fuel and air are pressed into one chamber, the volume of which can be changed by a movement of a piston; when the volume of air is compressed into the top of the cylinder, an ignition from the spark plug will heat the fuel and air in the chamber; the heated fuel and air will expand the volume of the chamber and so create mechanical power; then air goes out through the exhaust outlet on the cylinder and fuel and air are delivered again into the cylinder for the next cycle (two-stroke cycle engine).

The steam turbine engine invented by C. Laval in 1883 which operates like this: water is changed into steam with a high saturation vapor pressure, then the steam goes into a turbine (an axle with many blades) and rotates the turbine in order to generate mechanical power, then escapes from the turbine.

The Diesel engine, invented by R. Diesel in 1892 which operates on the same principle as the internal-combustion engine, but the ignition method is different: when the air is compressed in the chamber (piston and cylinder) to the top dead-center of the cylinder, the fuel is sprayed in the form of mist and burns itself under high pressure and temperature conditions, expands the volume of the chamber and generates mechanical power; the other strokes are exactly like those of the internal-combustion engine.

The gas turbine engine for airplanes was invented by P. Whittle in 1944 and operates in way: the engine is a cylinder tube; turbines are mounted inside and at both ends of the cylinder; the turbines at the two ends are joined by an axle located at the center of the cylinder; the reaction chamber is in the middle of the cylinder; air and fuel are injected into the reaction chamber where their reaction generates heat which expands the volume of gases in the chamber. The expanded gases move to the bottom of the cylinder and rotate the blades of the turbines and also rotate the turbines at the top of the cylinder, the rotation of turbines at the top extracts slightly compressed air for supply to the reaction chamber and here it mixes with the injected fuel and burns. Thereby the engine continuously operates.

The jet engine conceived and developed in Germany in 1944 and later used for rockets and spacecraft operates like this: the engine consists of a cylinder tube with one closed end and the other end which communicates with the atmosphere and a reaction chamber is disposed inside the cylinder; fuel and oxidant are injected into the reaction chamber where they mutually react; the heat of the reaction expands the gases which results from the burning of oxidant and fuel and causes them to continually jet bottom of the cylinder and creates the propulsion reaction force for the engine.

So far the generation of mechanical energy in a heat engine is expressed as follows: the engine extracts the heat energy from a high source and transforms a part thereof into mechanical power and a remaining part is introduced back a low source. The efficiency of an engine is calculated by the expression:
e=|W|/|Qh|=(|Qh|−|Qc|)/|Qh|

where W is the mechanical power produced by the engine, Qh is the heat energy extracted from the high source by the engine, and Qc is the amount of heat energy is returned to the low source by engine. Therefore, the highest efficiency of an engine can be about 1 when there is no heat returned to the low source as all the heat has been changed into mechanical energy. This way of explaining the generation of mechanical power is not safe in that there must be a low source to which heat energy can be returned after part of it has been changed into mechanical power. The expression as shown above could hardly be used to explain mechanical power generated by a rocket jet engine in space or other types of machines like electric generators, wind engines, etc. It is noted that based on the explanation of the two high and low sources, the possibility of improving or renewing heat engines in general and other engines in particular will be significantly limited.

On the other hand, this expression of mechanical power only changes the temperature of the environment (here factors of pollution of the products of the reaction is not mentioned), while many other changes are imposed on the environment when engines operate, such as the changes in pressure, density, and distribution of substance in space (leading to the dimension, density and distance change between matter components in the environment containing them)—this will be described in new physical concepts which are the foundation for producing the engines of this invention.

In heat engines such as the steam engine or steam turbine engine, except for the internal combustion engine, the change of physical states of water (from fluid to steam state) takes place rather slowly and water enters in the atmosphere as big-sized particles of water.

In gasoline and Diesel internal combustion engines, the change of physical states of the combustion products (fuels, oxidants and substances accompanying them) takes place with a certain speed because the fast chemical reaction of combustion and explosion leads to the fast expansion of these products; however, as the combustion takes place under a pressure which is not very high and especially as the density of both oxidant and fuel is rather low, the expansion rate (that is the comparison between the volumes of the same object after and before the expansion under the same pressure conditions) is much smaller than the expansion rate that would happen if they were either fluid or solid or condensed gas before the combustion; this will be described in detail below.

Jet engines used for different types of airplanes, rockets, spaceships, etc. operate with the combustion of fuel with oxidant or air and continually thrusts the combustion products in the atmosphere for forming jet thrusts; jet engines and air turbine jet engines have the following disadvantages:

1/ The combustion chamber is open to the outer environment and the combustion of fuel and oxidant occurs at a rather low pressure so that the concentrated temperature is relatively low.

2/ The density of fuel and oxidant is rather low and the expansion of the substance mass is not formed in a sudden manner; the resulting pressure after the combustion is still low.

3/ The combustion chamber is open to the outer environment and the differential pressures between the chamber and environment are not big; the velocity and the acceleration of the jet gas are low.

4/ The jet engine continuously accelerating an object moving with a high acceleration like a rocket or a spaceship consumes a great amount of useless energy.

5/ The mass of gas expands and thrusts out of the engine (of the jet plane or rocket) before it has reached optimal velocity and acceleration.

6/ Since the combustion reaction in the combustion chamber continuously occurs and the pressure in the chamber must be lower than the pressure in the fuel injector, the pressure in the combustion chamber is limited by the pressure of the fuel injector.

New physical concepts serve as the basis for producing the engines of invention:

So as to give a better illustration and overview of the generation of mechanical energy for the mechanical energy generating engines, this invention presents new physical concepts different from the current concepts as to the generation of mechanical energy in particular and as to the relationship between energy-generating factors from the “matter and space” pair in general.

The following experiments will illustrate the new physical concepts which will be fully explained further.

Experiment 1: (FIG. 1)

FIG. 1: Details of the equipment for Experiment 1.

Equipment Details:

In FIG. 1: a double-walled glass cylinder 1 of which the empty double wall 1a serves as an insulator; another smaller cylinder 1b is disposed at the bottom of cylinder 1a; a piston 2 is at the junction of the two cylinders 1 and 1b; the bottom of the big cylinder is 1c; at the top of the cylinder is the pipe 4 connecting cylinder 1 with an empty compartment 5; a valve 3 is fixed on the pipe 4; the empty compartment 5 has a large volume to create a stable vacuum pressure; a vacuum gauge 6 is fixed on compartment 5; a pipe 7 joins compartment 5 to a vacuum pump 9a with a valve 8 fixed on pipe 7; the space between piston 2 and the bottom of cylinder 1a is space 9 and the space between piston 2 and valve 4 is space 10.

Conducting the Experiment:

Methanol will be used in this experiment. The boiling points of methanol at different pressures are respectively: 64.7° C. at 760 mm Hg, 49.9° C. at 400 mm Hg; 34.8° C. at 200 mm Hg; 21.2° C. at 100 mm Hg; 12.1° C. at 60 mm Hg; 5° C. at 40 mm Hg; −6° C. at 20 mm Hg; −16.2° C. at 10 mm Hg; −25.3° C. at 5 mm Hg; −44° C. at 1 mm Hg.

Fill the small cylinder 1b nearly up to capacity with methanol at temperature of 30° C.; piston 2 is placed at 1c. Valve 4 is closed and valve 8 is opened in order to operate vacuum pump 9a. The vacuum pressure gauge 6 is checked; when pressure reaches approximately 0 mmHg, valve 4 is opened. At this moment space 10 has vacuum pressure and so piston 2 goes up and the methanol boils; then the piston moves more slowly when the methanol cools down and gradually stops boiling; finally the methanol stops boiling and the piston stops moving; when the piston stops, pressure in space 9 is higher than pressure in space 10, but because of the piston's weight, a equilibrium is established and piston 2 is positioned steadily at one point.

Experiment 2 (FIG. 2)

FIG. 2: Details of the equipment used in experiment 2.

Equipment Details:

Details in Experiment 2 are exactly like details in Experiment 1; thus, details in FIG. 2 are like those in FIG. 1; the only difference is, that the methanol although of the same quantity, is contained in a hermetic rubber balloon 7b placed in the small cylinder 1b.

Conducting the Experiment:

A hermetically closed rubber balloon containing methanol (of the same amount as in experiment 1) at 30° C. is placed in cylinder 1b; with piston 2 at position 1c, valve 4 is closed and valve 8 is opened, vacuum pump 9a is started; pressure gauge is checked and when the gauge approaches 0 mmHg, valve 4 is opened; at this moment, space 10 has vacuum pressure, but piston 2 is not moved much because space 9 contains very little air and the high pressure of methanol in the rubber balloon keeps the methanol from boiling; then the piston gradually moves up, the pressure of air saturated with methanol in the air balloon rises for creating differential pressures inside and outside the balloon, finally the balloon inflates and blows up; methanol is splashed around, some boils and evaporates leading to the cooling of the remaining methanol; piston 2 moves up very fast and reaches a higher point than in experiment 1.

Comparison of the Two Experiments:

The two experiments used the same amount of the same element (methanol); the methanol in both experiments has the same physical state with the same temperature, air pressure, and density (with the same fluid volume). But in experiment 1, the methanol boiled and evaporated gradually; this slow evaporation cooled the methanol that didn't evaporate and the difference in pressure between space 9 and space 10 was negligible. In experiment 2, the methanol was contained in the air balloon and there was a great difference in the pressure between space 9 and space 10; that is why, when the balloon exploded, the methanol was splashed around and boiled immediately, instead of cooling down like in experiment 1; this quick dispersion makes finer particles of methanol move faster (state of gas) than the bigger particles, which move more slowly in experiment 1 (state of condense steam); the result was that the piston in experiment 1 was made to move up higher than in experiment 2.

Conclusion: From the same quantity of matter of the same physical state under the same environmental condition (vacuum), the mechanical energy generated in the two above-mentioned experiments are different: the mechanical energy generated by the extra-fast expansion of methanol in experiment 2 is much greater than the mechanical energy generated by the slow expansion of methanol in experiment 1. At the same time, the size of methanol particles after experiment 2 (gas) is smaller than the size of methanol particles after experiment 1 (condensed vapor).

Experiment 3 (FIG. 3):

FIG. 3: Details of equipment for experiment 3.

Equipment details:

A metal cylinder 11 covered with an insulating wrapping 12 having its bottom end connected to a smaller cylinder 13; at the lower end of cylinder 13, a nut 14 is screwed on a thread part thereof so that it is possible to pump in water and to place the piston 15b at different positions as needed; the bottom of cylinder 13 is the upper surface 17; on piston 15b is a metal shank 15a that will allow observation the motion of the piston in the cylinder; a resistor 16 is placed in small cylinder 13 to heat the water in the cylinder; resistor 16 is fixed to a ceramic insulator 13b outside the cylinder; a metal sheet 18 is fixed on surface 17 by a layer of heat-resisting silicon glue 18a; space 19 is disposed between the bottom 17 of cylinder 11 and the lower surface of piston 15b; the space above the piston is communicated to the atmosphere (with atmospheric pressure). A heat sensor 20 is fixed on cylinder 11; this sensor is connected to thermometer 20a on the outside.

Conducting the Experiment:

A quantity of fluid water at 30° C. is introduced into cylinder 13 (see table below for boiling points of water at different pressures), piston 15b is positioned on metal sheet 18; a timer is started at the moment when the resistor is connected to a stable electric power; water is heated by the resistor and its temperature goes up to over 100° C. but as the saturation pressure of vapor in space 19 increases, the water does not boil yet and the piston does not move; the temperature continues to go up leading to the rapid increase of the saturation pressure of vapor in the space 19 and finally the layer of silicon glue 18a comes loose in order to release the metal sheet 18 from surface 17; the saturated water and vapor in cylinder 13 overflow into space 19a so that piston 15b is moved up. When hearing the low explosion of the metal sheet 18 ejected from surface 17, the timer is stopped and the electric supply for resistor 16 is switched off; when piston 15b reaches its highest point, this place is marked and the temperature on the thermometer is read.

Experiment 4 (FIG. 4)

FIG. 4: Details of equipment for experiment 4.

Equipment Details:

All details are similar to equipment for experiment 3 and numbered the same way, the only difference is the absence of the metal sheet 18 and the layer of glue 18a; the amount of water introduced into cylinder 13 is the same as the water in experiment 13 with the same temperature of 30° C.

Conducting the Experiment:

Water is introduced into cylinder 11 and the piston is positioned on surface 17; the timer is started and the time is recorded when resistor 16 is connected to stable electric supply as in experiment 3; the resistor heats the water in cylinder 13 and makes it boil; the piston moves up slowly; the timer is checked and the electrical supply to the resistor is switched off when the same period of time as in experiment 3 has gone by; the place reached by the piston is marked and the temperature on the thermometer is recorded, it will be noticed that the movement distance of position is shorter than in the previous experiment but the temperature in the thermometer is higher.

Comparison of the Two Above Experiments:

The two experiments used the same amount of water; the water was heated by two similar resistors 16 with the same electric supply for the same period of time (so, the energy supplied to the two water amounts were the same); at the same time, the upper surface of the piston 16 was in contact with air pressure. However, in experiment 3 the piston moved up much higher than in experiment 4 while the temperature of the steam was much lower than in experiment 4.

### CONCLUSION

The same amount of energy was supplied to the same amount of fluid but two different methods of changing the physical state were used: in experiment 3, water was made to change its physical state very fast while in experiment 4 water was made to gradually change its physical state. The results were that the mechanical energy generated in experiment 3 is much greater then in experiment 4, as proved by the piston which moved much higher in experiment 3 than in experiment 4, and that the temperature of the volume of gases in experiment 3 was lower than in experiment 4, and that the expansion of the volume of gases in experiment 3 was greater than in experiment 4.

Experiment 5 (FIG. 5):

FIG. 5: Details of equipment for experiment 5.

Equipment Details:

The details of the equipment for experiment 5 are exactly like those for experiment 3 and were numbered the same way, except for one detail: piston 15b is positioned at a distance from surface 17 rather than right on this surface at the beginning of the experiment, which means that the atmospheric-pressured space 19 is already big at the beginning of the experiment.

Conducting the Experiment:

An amount of fluid water at 30° C. is introduced in cylinder 13, piston 15b is positioned at a distance from metal sheet 18; the timer is started and the time is recorded when the resistor is connected to the electric supply; the resistor heats the water up to over 100° C., piston 15b goes up a little because the air in space 19 is heated and expands a little but water still does not boil because the steam saturated pressure is increased in a closed space; the temperature is increased so that the pressure of saturated steam is highly increased and finally causes the layer of glue 18a to separate from surface 17; the saturated water and steam in cylinder 13 flows into space 19 and pushes piston 15b up; the highest place of the piston is marked and the temperature is read on the thermometer.

Comparison of Experiment 3 and Experiment 5 and Conclusions:

The distance covered by the piston 15b in experiment 5 is longer than the distance covered by piston 15b in experiment 3. Although the same amount of water was used, and it had the same pressure, temperature, initial density, received the same kind of heating from the resistor 16 with the same electrical energy (as the upper surface of piston 15b was in contact with atmospheric pressure in both experiments), the piston moved a much longer distance in experiment 5 than in experiment 3 because the large space which took place in this space before the experiment allows the water molecules to reach optimal velocity and acceleration (when water changed its physical state) before acting on piston 15b so that piston 15 would move and generate mechanical energy. The temperature of water (as steam) in experiment 5 was lower than in experiment 3 because the volume occupied by the mass of water is larger.

Experiment 5 shows the relationship between matter (with certain initial conditions like temperature, pressure, density) and the space (volume) newly occupied by that matter or the extent of dispersion of matter (or the dimension of the beams of molecules of that matter) and the energy generated when there is a change in physical states at different times.

Experiment 1 is the same as if we take a gigantic sphere of methanol into space (a vacuum environment), the methanol on the surface of the sphere will boil violently and generate mechanical energy because of the evaporation; then the temperature of the sphere of methanol will gradually decrease; an atmosphere will form on the surface of the sphere of methanol and get thicker and thicker; if the sphere of fluid methanol is large enough to create an attraction between this atmosphere and the sphere of fluid methanol, the sphere will cool off and the boiling on the surface will stop, then only the phenomenon of evaporation occurs; later, the sphere of methanol will become cold enough to start changing into solid state and the evaporation will become sublimation; then the evaporation becomes negligible and the sphere of methanol will reach the state of equilibrium with the surrounding environment and stop generating mechanical energy.

Experiment 2 is like taking the same amount of methanol into space but this methanol is in innumerable small spheres instead of one very big sphere. All the methanol will boil and evaporate immediately and the phenomenon of molecules cooling off will not take place. All the matter will be turned into mechanical energy because the methanol will boil and evaporate before it can reach the state of equilibrium with the surrounding environment as in the earlier situation.

Experiments 3 and 4 are also similar but a mass of water is used instead of methanol; this water is placed in atmospheric pressure and heated so as to create a difference in pressure with the environmental pressure. So in experiments 2 and 3 we have broken the process of reaching the state of equilibrium of the mass of water as happens in experiments 4 and 2. Thus, the bigger the amount of mechanical energy generated, the faster the process of dispersing matter from a denser physical state into a less dense physical state; and the bigger the space occupied by the dispersed matter, the smaller the size of the beams of molecules after dispersion. (The expression PV=constant does not apply to this extra fast change of physical state, as this expression does not take into account the dimension of the beams of molecules before and after the process of dispersing matter into space).

Experiment 5 shows that the generated mechanical energy will be greater if the beams of molecules in the process of changing the physical state are allowed to reach an optimal velocity and acceleration before they act on the members of the engines to generate mechanical energy.

Therefore, there is a relationship between the speed with which matter changes from one physical state to another—this change of physical state will make matter take up more space in the environment, whether it is the empty outer space or the atmosphere around the earth—and the extent of dispersion of matter after the change of physical state (dimensions of the beams of molecules of matter and distances between them) and the energy generated by the change of physical states. However, as the environment of the outer space of the universe and the atmosphere of the earth is considered to be unlimited, for the same quantity of matter with the same initial physical conditions such as temperature, pressure, density, the ability to generate mechanical energy is greater when the change of physical state is faster, and at the same time, the space occupied in the surrounding environment is greater when dimensions of the molecules of matter after the dispersion is smaller.

The table and diagram below show the relationship between the temperature of water and the saturated pressure of a number of substances. It can be seen that the higher the temperature, the faster the saturated pressure increases in comparison with the increase in temperature, especially true with substances with molecular structures taking up much space like water or ethanol while with substances with molecular structures occupying little space like hexane, acetylene or acetone, although they have low boiling points at ordinary temperature, they do not create high saturated pressure at high temperatures as their beams of molecules do not take up much space.

Therefore, if an engine is capable of heating a fluid such as water and keeping this fluid in this physical state at a temperature as high as possible before the water is changed into vapor, the energy supplied to the engine for the heating will be much less in comparison with the mechanical energy obtained when the water with extreme speed changes its physical state from fluid into vapor with a high degree of dispersion of fine particles of water in the environment (as the difference between the pressure of the saturated steam and the atmospheric pressure is very big). That is why water plays a very important role for maintaining temperature and pressure in the atmosphere.

If other fluids with lower boiling points are used instead of water, such as fluid nitrogen, fluid oxygen, fluid hydrogen, solid CO₂, fluid lithium, or lithium compounds, the energy generated will be much greater while the supply of energy for heating these substances will be much smaller.

As a result, if fluid nitrogen, solid CO₂, fluid oxygen (which is used together with fuel for aircraft and spacecraft to accelerate flying objects in high atmosphere or in outer space) is produced in regions with low temperatures around the year (between −30° C. and −60° C.) and they are used in other regions, the engines must not be made of heat-resisting material and will be simpler and lighter.

From the above compared experiments and conclusions, and for purposes of replacing the explanation of the generation of mechanical energy by the model of hot source and low source, and for enhancing the efficiency of heat engines and building a new foundation for a new method of extracting energy: the energy obtained from the dispersion of matter in the surrounding environment is greater when, as the result of the dispersion, the dimensions of the molecules are smaller and the distance between the molecules is greater, this invention presents new physical concepts on the relationship between matter and its surrounding space (distribution of the molecules, acceleration of the molecules, etc.) with energy as follows:

New Concept 1 (Relationship Between the Distribution of Matter in Space and Energy):

The pair of matter and surrounding space containing them (environmental spaces like the atmosphere surrounding the earth or the outer space of the universe are considered to be unlimited) have energy values which are generated when there is a redistribution of matter (or change of physical states) in the environmental space surrounding it; the greater the value of the generated energy, the smaller the dimensions of the molecules of matter (beams of particles or particles) and the smaller the density of the molecules, the greater the distance between these molecules (which takes place when the process of redistribution of molecules takes less time.)

When matter has low density (that is, when a small amount of matter occupies a large space, like in vapors, gases, plasma, etc.) the molecules (particles or beams of particles) of matter (such as particles of mist, molecules of gases, ions, etc.) are not evenly and continuously distributed in the space containing them. On the contrary, they are dispersed unevenly forming beams of molecules (in these beams, the distances between the particles are enormous in comparison with the dimensions of the particles). Also, the dimensions of the elemental matter (beams of particles or particles) and the density of these molecules and the distances between the molecules (or the extent of dispersion of matter in the space containing it) express the value of the remaining energy of the pair of matter and the space containing it.

At high temperatures when the molecules are not yet disintegrated and changed into another physical state, the pressure of saturated vapors of substances tends to depend on the dispersion of the molecules of matter contained in that space; the higher the pressure of that space, the greater the dimensions of the beams of matter tend to be and the smaller their density (or their molecules of composite structure will occupy more space), whereas the lower the pressure of the space, the smaller the dimensions of the molecules remaining as beams and the bigger their densities.

In the table and diagram that is shown below, the relationship between the temperature and the pressure of saturated steam in a number of substances, at high temperatures such as at 2000° C. when molecules of matter are not yet disintegrated, the pressure of saturated steam tend to be high with substances whose molecules are formed with few atoms and the cubic molecular structure takes up much more volume.

In the process of dispersion of matter in a specified space in the same period of time (e.g. in a combustion chamber or a chamber specially arranged for the change of physical states of matter), the total force of all the particles of the mass of matter acting on members of the engine that generate mechanical power will be much smaller compared to the total force of all the particles of matter as small beams or as incoherent particles acting on the energy-generating members of the engine. Since the total moving distance of all the particles of matter as large beams will be much shorter than the total moving distance of all the particles of matter as small beams or as incoherent particles although happening in the same time and place, i.e. during the process of dispersion of matter into a specified space, the acceleration of each particle of matter in a small beam or as an incoherent particle will be much greater than the acceleration of each particle of matter in a large beam.

This could be shown geometrically as follows: in the first case, suppose that 2 particles form a beam, in which the distance AB between the 2 particles is AB>0, and in the second case, these 2 same particles form a beam, the distance A′B′ between the 2 particles is A′B′=0. In the first case, when 2 beams move on the same distance MN in the same period of time, the total moving distance of 2 particles of the beam is MA+BN, where MA=NB<MN, whereas in the second case, the total moving distance of 2 particles of the beam is MN+MN=2 MN. Therefore, 2 MN>>MA+BN in the same period of time.

The amount of energy generated by the process of transforming the physical states of water from fluid to mist of water vapor will be much smaller than the amount of energy generated by the process of transforming water from fluid to vapor.

As the space where matter can be dispersed like the atmosphere of earth or outer space of the universe is considered to be unlimited, the energy value of the “pair of the matter and space” is only generated when the process of dispersion of matter into space is occurred; the greater said generated energy will be, the smaller the particles of matter after the dispersion and the smaller their density, the greater the distance between them.

In is possible to express this in the contrary: the remaining energy of the “pair of matter and space” depends on the dimensions of the matter particles and their densities in the specified space, and the smaller the remaining energy of the “pair of matter and space”, the smaller the dimensions and densities of the matter particles and the farther they are from each other.

Concept 2 (Relationship Between the Increase/Decrease of the Volume of Matter and the Acceleration of the Particles of Matter in the Process of Contraction/Dilation)

When a mass of matter changes its physical state and expands to take up more space, the particles of this mass (beam of particles or particles) will move with a positive acceleration (if the transformation of physical states takes place at higher speed, there will be fewer mutual collisions between the smaller particles which will tend to move in a straight direction; if the transformation of physical state takes place at slower pace, there will be more mutual collisions of the bigger particles which will tend to move in zigzag and to rotate around themselves). On the other hand, when a mass of matter contracts and occupies less space, its particles will move at negative acceleration.

Concept 3 (Relationship Between the Generation of Mechanical Energy of an Engine and the Acceleration of Matter Particles During the Operation of the Engine):

An engine generates mechanical energy, the operation thereof must change the existing acceleration of the matter particles in the process of transformation of physical states, with the tendency of decreasing this acceleration.

Concept 4 (Relationship Between the Resulting Mechanical Power from the Engine and the Velocity and Acceleration of the Matter Particles in the Process of Transformation of Physical States):

An engine will generate the greatest mechanical power when the operation of the engine decreases the existing acceleration of the particles of matter during the process of transformation of physical states when these particles obtain the acceleration around the greatest value (the acceleration of the particles changes when the mass of matter starts changing its physical state).

Concept 5 (Relationship Between the Acceleration of a Moving Object and the Consumed Energy; Applicable to the Acceleration of Flying Objects Like Rockets, Airplanes, Spaceships, Satellites, etc.):

A continuous acceleration of a moving object with its acceleration will consume more energy than an interrupted acceleration thereof; the best way is to repeatedly accelerate such an object is when the acceleration is returned about zero.

In order to obtain energy from the “pair of matter and space”, it is necessary to bring the mass of matter to the state available for dispersion and as far away from the normal equilibrium as possible, with the purpose to prevent the mass of matter from changing its density in the process of heating and from dispersing into the surrounding space before reaching the optimal readiness for dispersion, when it will be at a temperature much higher than its normal boiling point; when the process of dispersion takes place, the mass of matter will be dispersed at an extra high speed into the surrounding space and the particles of matter will be broken into small beams in this process; these beams will move in straight directions with positive acceleration; then the members of the engine will reduce the existing positive acceleration of said beams to generate mechanical energy. This method of producing energy is called energy generating by dispersion of matter.

Basing on the above concepts, in order to produce energy generating engines with a high effects, the following requirements have been met:

the availability of solids and fluids with low boiling points and easily obtained;

a mass of solids or fluids is conducted to a very high temperature and pressure at which the material of the engine could stand without changing their density;

the possibility of suddenly dispersing said solids and fluids into small particles in the low-pressured surrounding space; this surrounding space needs to be large enough for the particles to reach optimal velocity and acceleration (so that after the dispersion; the particles will have as small dimensions as possible with distances between them as great as possible and the dispersion should be as fast as possible).

Mechanical energy is generated when the members of the engine reduce the acceleration of the particles in the process of transformation of physical states caused by the dispersion;

The engine that generates mechanical energy will operate as follows: an amount of fluid with a low-boiling point like water, fluid nitrogen, or an amount of CO₂ powder is introduced into a compartment (external to the engine) made of a material that can stand high temperature and pressure; the fluid is heated to as high a temperature and pressure as the compartment can stand; the heated fluid is then transferred into a closed compartment inside the engine, also made of a material that can stand a high temperature and pressure; the fluid is heated again in the inner compartment; then the inner compartment is suddenly opened, the fluid flushes into an adjacent compartment which has a low atmospheric pressure; the mass of heated fluid will disperse with high speed in the space of the new compartment causing a very high pressure; this pressure will move a piston or rotate a turbine to create mechanical energy, or will spout out to create a jet propulsion for the engine. Such an engine is called a fluid dispersion engine (although it is possible to use solids, it is better to use fluids).

### BRIEF DESCRIPTION OF THE DRAWINGS

Objects, advantages and features of an engine of embodiments of the invention will be described below with reference to the accompanying drawings, in which:

FIGS. 1-5 are schematic views showing experiments which are performed to illustrate the new principles producing the engine of the invention,

FIG. 6 is a cross section view showing the explosive fluid engine of straight piston cylinder and heated fluid containing member of an embodiment of the invention when piston is in the middle of the cylinder,

FIG. 7 is a cross section view showing the engine and fluid containing member when piston is in the head of the cylinder,

FIG. 8 is a cross section view showing the engine and fluid containing member when piston is in the middle of the cylinder having a driving rod and fly wheel,

FIG. 9 is a cross section view taken along line A-A through the big piston and the big cylinder,

FIG. 10 is a fragmentary perspective view showing the engine and heated fluid containing member,

FIG. 11 is a cross section view showing an engine of fluid dispersion of rotary chamber and of the fluid heating member of an another embodiment of the invention,

FIG. 12 is a straight cross section view of the engine and the heating member in FIG. 11,

FIG. 13 is a fragmentary perspective view showing the engine and the fluid heating member,

FIG. 14 is a cross section view showing an explosive jet cylinder piston engine having a partition when the piston is in the top position of the cylinder,

FIG. 15 is a cross section view showing an engine of FIG. 14 when the piston is in the bottom position of the cylinder,

FIGS. 16, 17 and 18 are the cross-section views taken along line A-A, B-B and C-C, respectively,

FIG. 19 is a cross section view showing an engine when the piston is in middle position of the cylinder, with the engine having a connecting rod and a fly wheel,

FIG. 20 is a fragmentary perspective view showing the engine of FIG. 14,

FIG. 21 a vertical cross section view showing an explosive engine with a partition of an embodiment of the invention through the center axle of the engine,

FIG. 22 is a cross-section view of the engine taken along line A-A of FIG. 21,

FIG. 23 is a fragmentary perspective of the engine of FIG. 21,

FIG. 24 is a cross-section view showing a modification of the engine of FIG. 21, in which a discharge tube is attached in another position thereof, and

FIG. 25 is a graph showing the relationship between the temperature and pressure of saturated vapors of several substances.

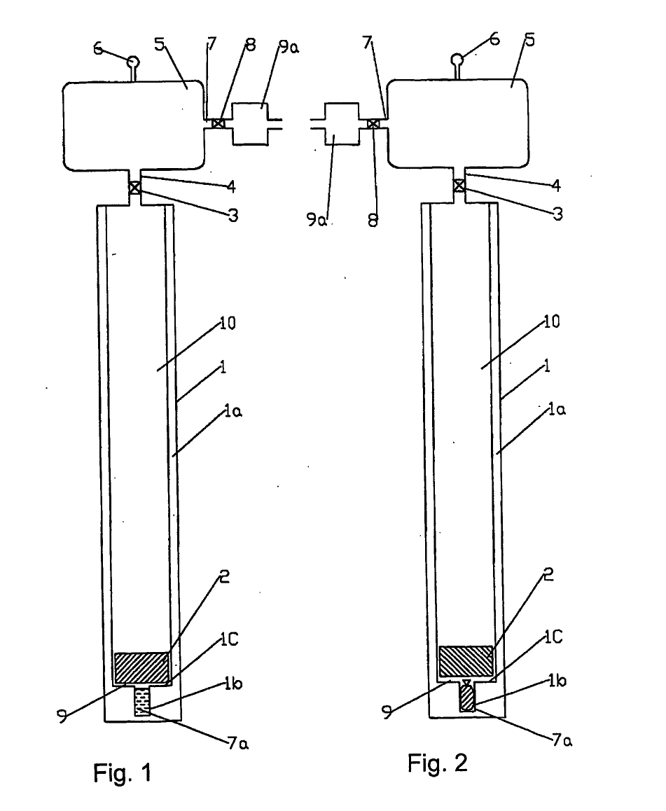

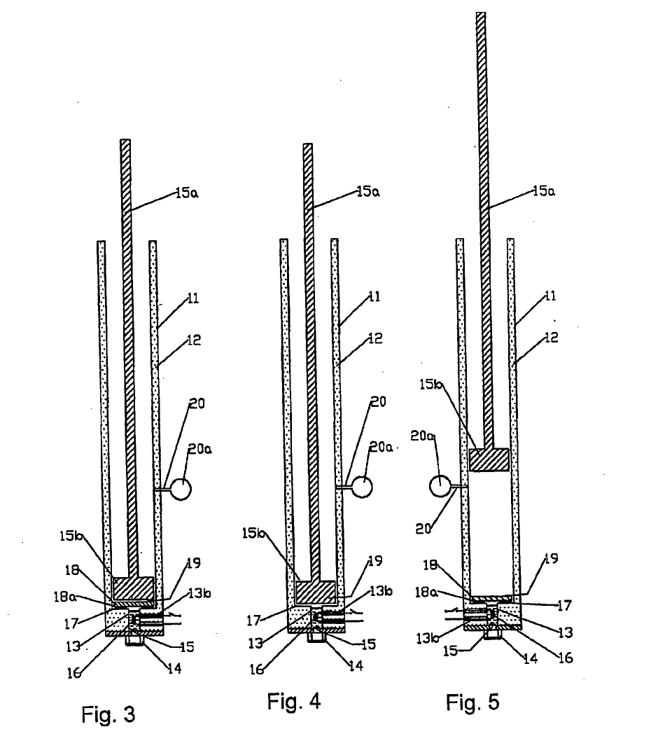

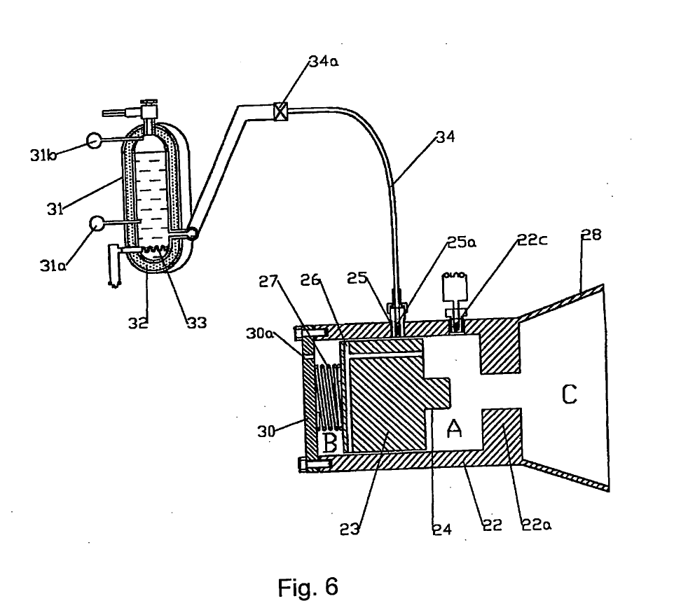

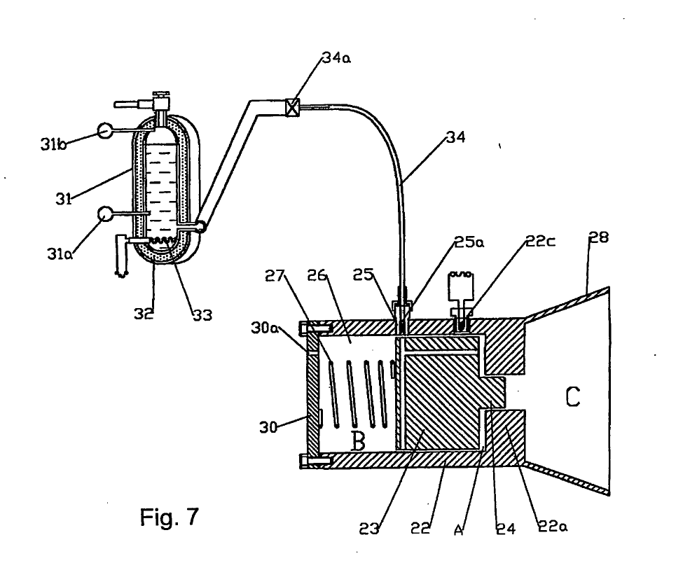

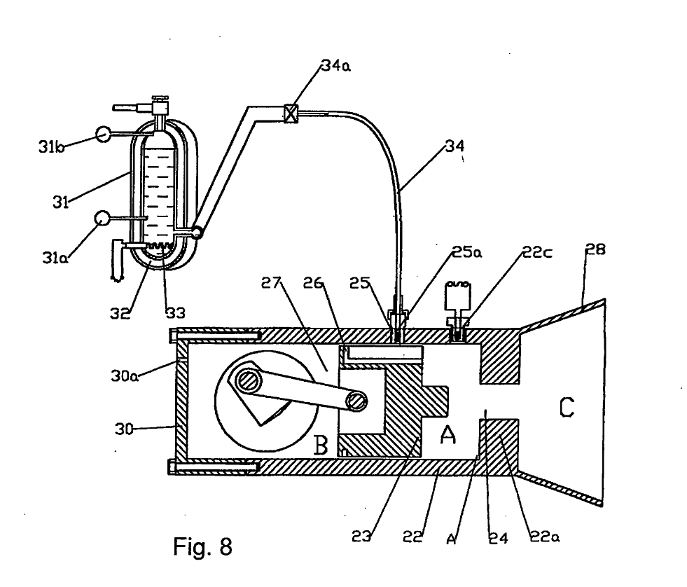

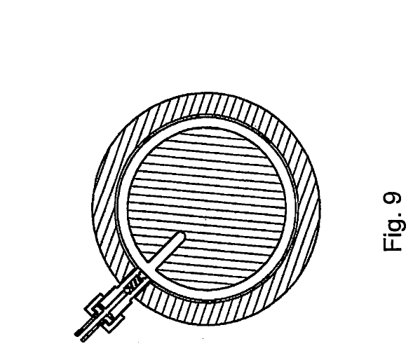

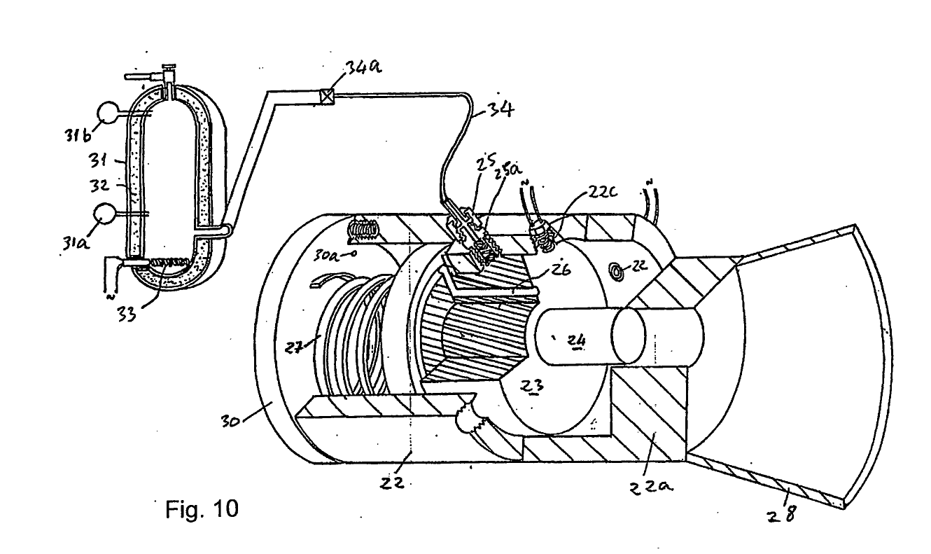

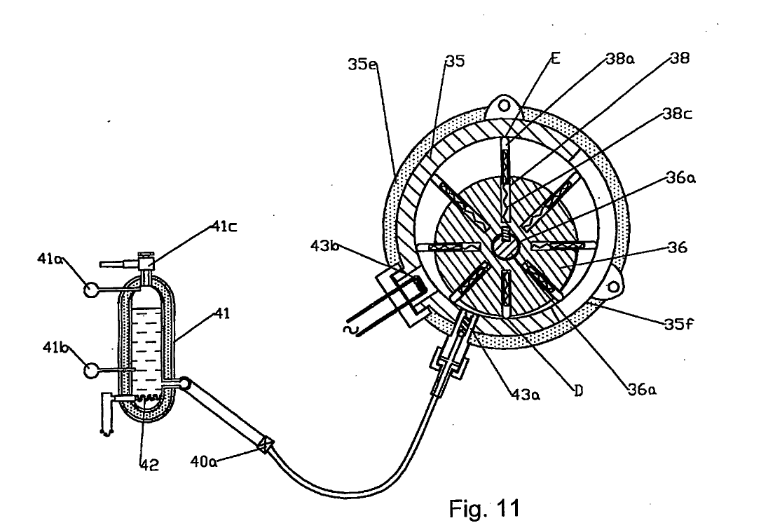

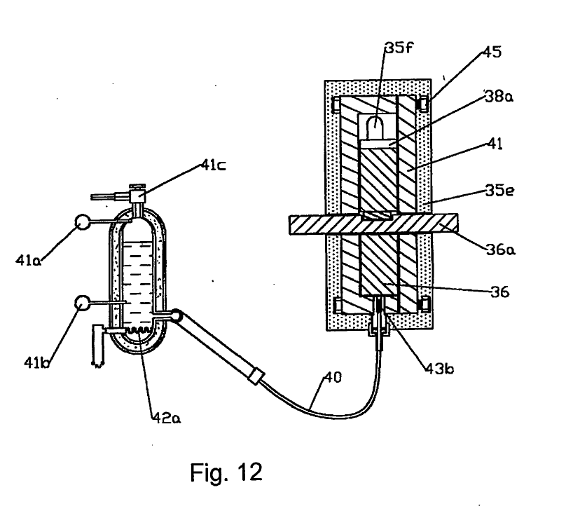

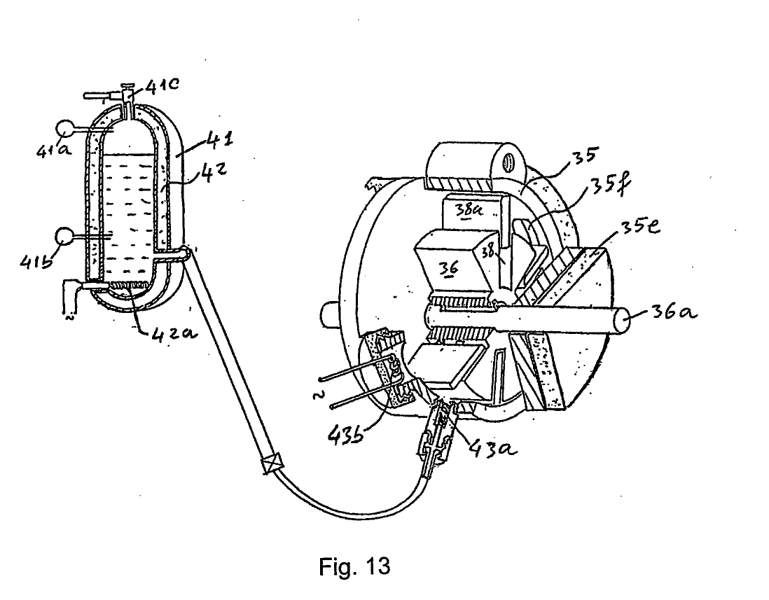

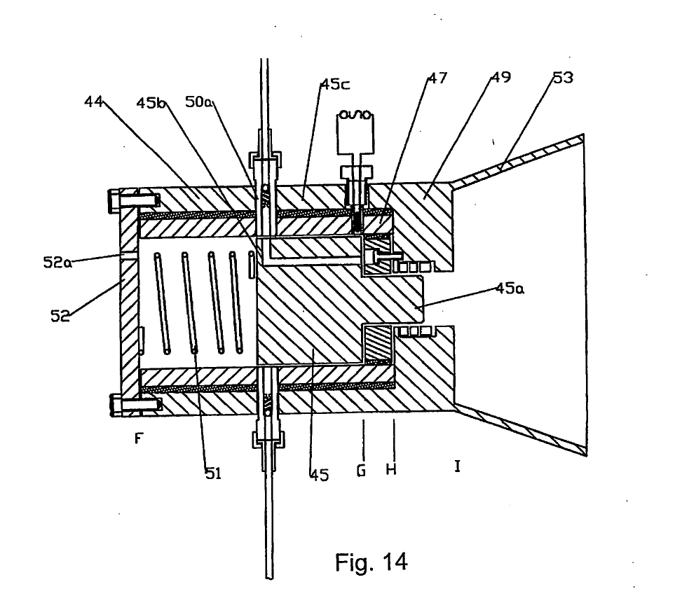

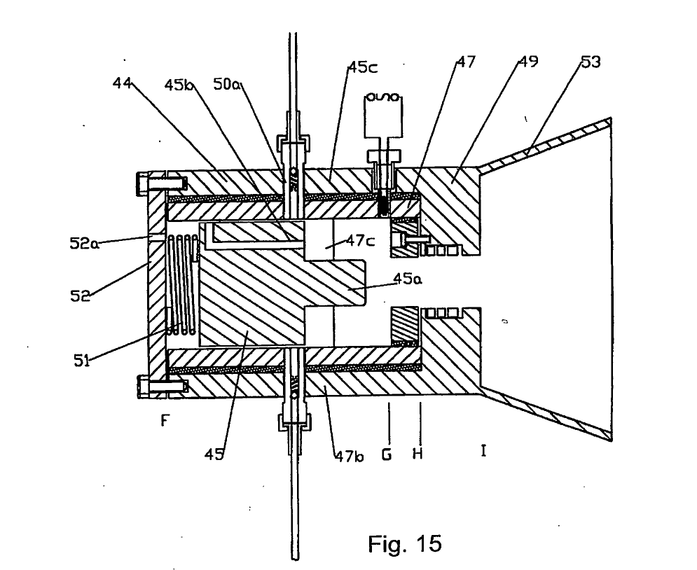

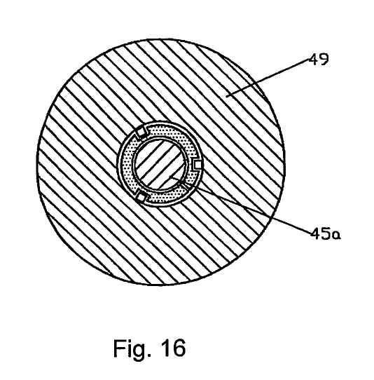

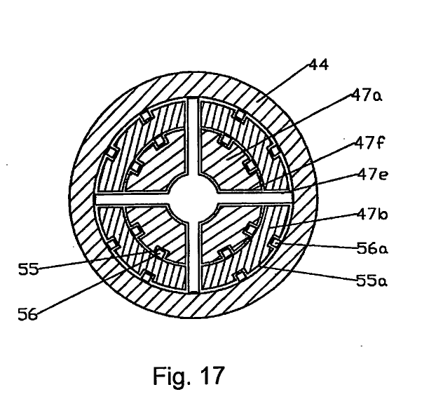

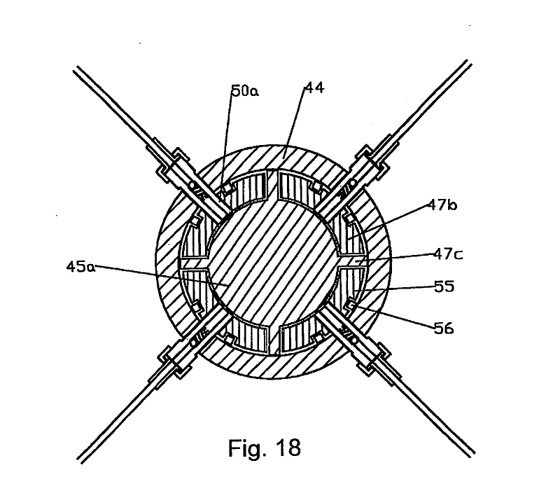

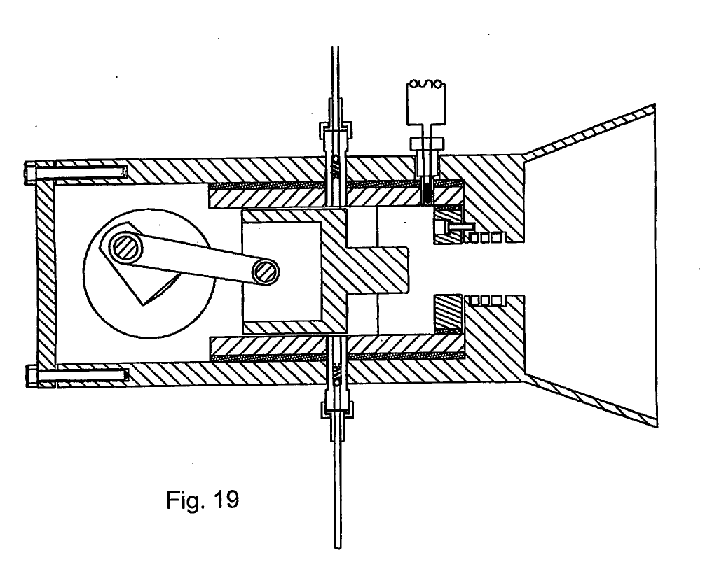

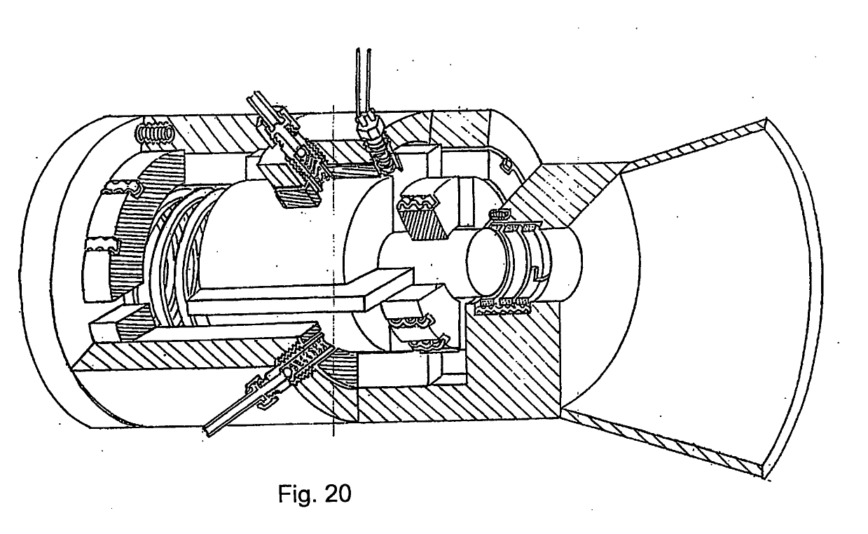

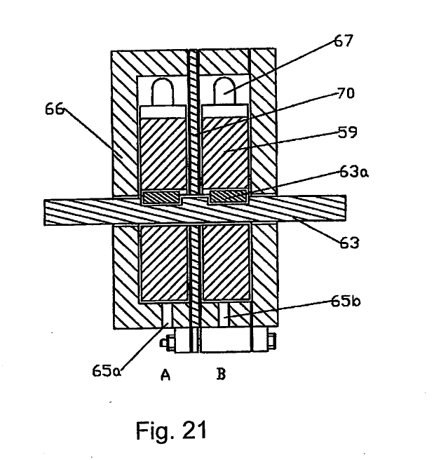

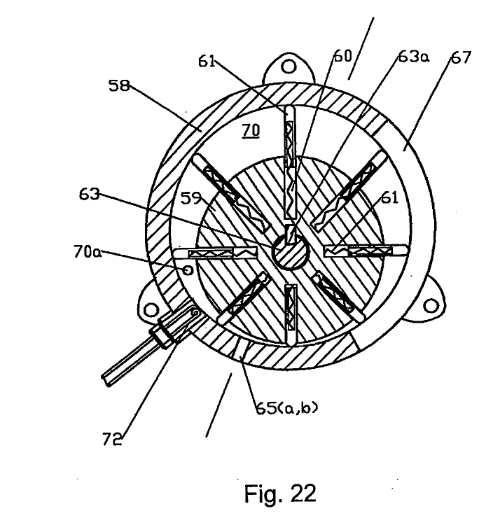

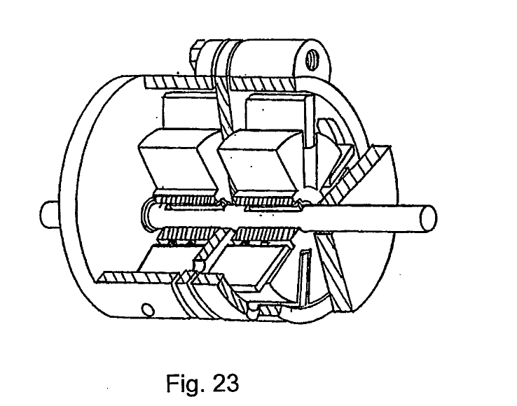

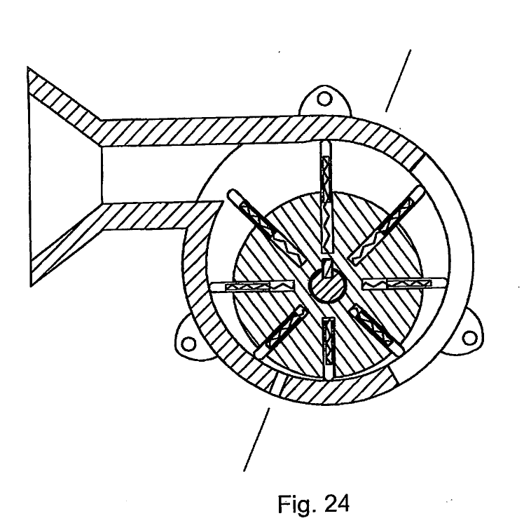

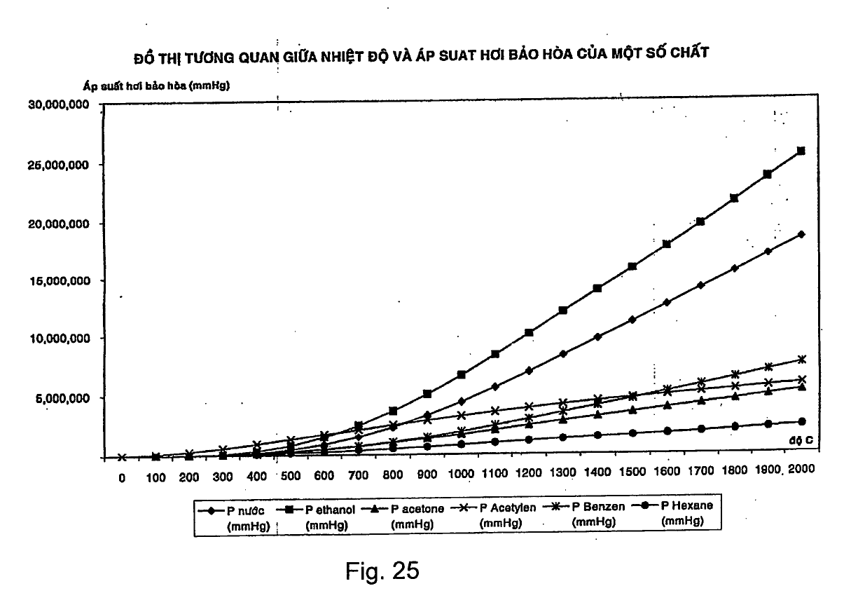

### MODE FOR CARRYING OUT THE INVENTION

The explosive fluid engine of straight piston cylinder consists of the big cylinder 22 in a circular tube shape, an end portion of the cylinder is connected to a cylinder 22a of circular tube having a smaller diameter and cylinder 22a connected with a funnel-shaped tube 28. In the inside of the big cylinder 22, a piston 23 is connected to a smaller piston 24 at its end. Diameter of piston 23 is the same as the inner diameter of the big cylinder 22 and diameter of small piston 24 is the same as the inner diameter of cylinder 22a. Thus, when a block of two connected pistons is moved, big piston 23 slides into cylinder 22 and a small piston can slide into cylinder 22a. A fluid conducting hole 25 is formed on the body of cylinder 22 at a position so that when big piston 23 is located adjacent to cylinder 22a, the hole 25 is aligned with a hole 26 on the inside of piston 23. One-way valve 25a of balls and spring is mounted on the outside of hole 23. Valve 25a is connected with a duct 34. This duct is connected with one end of a fluid adjusting valve 34a. The other end of the valve 34 is connected with a pressure and temperature resistance bulb 31. Bulb 31 is insulated by a insulation foam 32. A resistor 33 disposed in the bulb is connected with the electricity source for regulating automatically temperature. A thermometer 31a and a manometer 31b are also attached to bulb 31. A resistor 22c surrounding the perimeter of cylinder 22 is attached to the body of the big cylinder 22 adjacent to small cylinder 22a. The resistor 22c is connected to an electricity source. A spring 27 is attached to the bottom of the big piston 23 and the end of spring 27 is attached to the bottom of cylinder 30 on which there is a gas discharge hole 30a. The space from the piston surface to smaller cylinder 22a is called space A, from the bottom of the big piston 23 to the bottom of cylinder 30—space B, and the space within funnel-shaped tube 28—space C.

Operation of the Engine

Connecting resistor 22c with electricity source in order to heat the body of the cylinder and the neighboring area of resistor 22c up to about 900° C. The bulb 32 contains fluid (boiling easily). It is water or fluid nitrogen. Resistance 33 is connected with electricity source to heat the water in the bulb 31 up to 500° C. At that time, the pressure of saturated vapor in the bulb is about 96,098 mm Hg. When valve 34a is opened, the fluid flows through the valve 34a to one-way valve 25. Because of the position of the big piston 23 is near to the top of the big cylinder, a hole thereof is communicated with hole 26 on big piston 23, the fluid flows through hole 26 of piston 23 and into space A. Here, the fluid is heated again by resistance 22c, the greater saturated vapor pressure pushes the block of piston (of both big piston 23 and small piston 24 joined one another) towards the bottom of the cylinder. When starting to move, the body of the big piston 23 pushes a ball 22a of valve 25 up and thus closes valve 25, the fluid stops flowing into space A. The fluid in space A continues to be heated and then it is partially vaporized and the block of pistons is pushed until small piston 24 moves from small cylinder 22a. Fluid and vapor with a high pressure and temperature near to 900° C. suddenly are discharged from space C of funnel shape 28 through the inner face of cylinder 22a. Atmospheric pressure of the space is about 760 mmHg. The saturated vapor pressure of the fluid at 900° C. just escaped is 3,311,461 so the fluid and vapor are expanded extremely fast, then the particles of water are changed into condensed vapor and as gas have extremely high acceleration. The expanded gas in space C can be used to eject straightforwardly into the atmosphere so as to provide a pushing force as of the jet engine in which the outer wall of cylinder 22a (one wall of the chamber of space C) is a member of the engine decreasing the acceleration of the particles during the expansion. In space C, it can be equipped with a turbine so as to change the acceleration of particles of water being fast expanded and decrease the acceleration by the turbine generating mechanical energy during the rotation thereof.

If connecting a turbine with a generator and using a part of the generated electricity for supplying resistance again (many times as great as that of the source electricity), other electric power is produced by changing the state of fluid into the gas state extremely fast in the atmosphere space.

Engine of fluid dispersion of rotary chamber for producing mechanical energy:

The engine consists of a cylindrical block 36, in the middle of which is a core 36a. On the perimeter surface of the cylindrical block 36 there are radial slits 38 and a plate of rectangle 38a, a length of which is correspond to that of the cylindrical block 36, is placed in each of slits 38. A plural of springs 38c which make the rectangular plates 38a come apart far from the center are disposed on a portion near to the center of the cylindrical block 36. A cylindrical block 36 with the rectangular plates 38a has a diameter greater than that of cylinder 35 but is the same length as that of this cylinder and is offset from the center so that the outside tangent of the cylindrical block 36 contacts the inside of big cylindrical tube 35. Point D between the cylindrical block 36 and the inside of the cylinder is called a contacting one. And the opposite point at which rectangular plates 38a contacts with the inside of big cylindrical tube 35 is called point E. Two electric contacting surfaces of the cylindrical block 35 and cylinder 36 are plane surface 44 fastened by rivets and spring 45 so as to these two surfaces 44 can be fixedly held and flexibly kept when the heat expansion of solid of the cylindrical block 36 and big cylindrical tube 35 occurrs. Consequently, cylindrical block 36 with plates of rectangular 38a and the inside of big cylindrical tube 35 form many chambers whose volumes can be changed when the cylindrical block 36 rotates clockwise (or designed counterclockwise). The volume of chambers is small at positions near to point D, and becomes greater and greater when approaching point E. At the position of seven o'clock nearly point D (the positions of cross-section of big cylindrical tube is considered those of the numbers on a face of watch), there are a series of holes 43a on the body of big cylindrical tube 35, and a little far from point D in a clockwise direction in the 8 o'clock position is a heating resistor 43b. Hole 43a is communicated with a tube 40. This tube is connected with a fluid adjust valve 40a at one end thereof. And the other end of this valve, which is connected to a bulb 41 made of heat and pressure resistance material, a wall of insulation foam 42 is provided. A thermometer 41b and a manometer 41a are mounted on the bulb. At a its upper portion, bulb 41 is provided with a lock valve 41c for pouring fluid into bulb 41 and an automatic temperature adjusting resistor 42a. A gas discharge hole 35f extends from 2 o'clock to 5 o'clock (in the position of needles of the clock). The body of the cylinder is coated by a foam 35e so as to retain the high temperature of engine.

Operation of the Engine.

Water is fed into bulb 41 through a duct of a valve 41c, valve 41c is then closed. Heating resistance 42a is connected with an electric source, this resistance automatically heats the water up to 500° C. When the temperature of the water in the thermometer corresponds to the pressure of respectively saturated vapor of 469,098 mmHg, a flow rate adjust valve 40a is opened, the water flows into valve 40a through duct 40 and then through hole 43a of cylinder 35 to enter into the chamber surrounded by cylinder 35, cylindrical block 36 and two rectangle plates 38a. At a position D of the volume chamber near the smallest one (the chamber is in the 7 o'clock position), the fluid pressure expands the chamber and the chamber is moved in the clockwise direction. When plate of rectangle 38a goes away from hole 43, a new chamber receives the water in the 7 o'clock position and the preceding chamber is placed in the 8 o'clock position (in the clockwise direction). At this position, the fluid in the chamber is additionally heated by means of the available heating of resistance 43b so that the chamber is continually expanded and pressure of the chamber provides a rotation of the chamber in the clockwise direction. As a result, a cylindrical block 36 with core 36d are rotated so as to generate mechanical energy. The chamber then continues to expand beyond the position E, reaching to the position of 2 o'clock, and meets a long discharge hole 35e (from the 2 to 5 o'clock positions) and the block of gas is discharged from discharge hole 35f and moved to position D so as to finish one cycle. This is alternately performed in the chambers.

As in an engine of straight chamber type, in engine of rotary chamber type, if connecting the rotary axle with a generator having power equivalent to mechanical energy generated, the electric power produced by the generator partially compensates the resistors while the remaining part, is effective electric power since water and environmental space are generated by changing their state to disperse in the atmosphere extremely fast.

An application following an extremely fast changing state by dispersing in the atmosphere (extremely fast expansion) is the creation of a very big positive acceleration of the expanding particles in order to produce explosive jet engines, wherein the materials changing states extremely fast are two of kinds products: oxidized substance and fuel which are formed from the reaction conditions in a high pressure atmosphere and a thick density of the ingredients participating in the reaction.

Differing from conventional explosive jet engines, since the combustion chamber and the external atmosphere are communicative to each other, the differential pressure between the combustion chamber, fuel and the pressure of external atmosphere is not significant.

In the explosive jet engine of the invention, since the chamber in which the reaction between the fuel and oxidized substance occurrs is closed during the reaction, when the reaction occurrs, the initial heat energy generates a high temperature in the reaction chamber and a fast spreading pressure. Therefore, most of the fuel and oxidized substance reacts in an atmosphere of high temperature and pressure with a thick density of fuel and oxidized substance.

The reaction occurrs under such conditions causes a great differential rate between the pressure of the reaction chamber and that of the external atmosphere. When the products of the reaction are discharged from the reaction chamber, it converses the physical state very quickly to form very small particles so that particles move with a high acceleration so as to form a high pushing force for the explosive jet engines.

On the other hand, the acceleration of objects requires a high speed. The explosive jet engine repeatedly creates an interruption pushing force, the acceleration in interruption mode for rockets, space shuttles is very effective, economic and fast.

The Principle of Operation of the Engine.

Two elements: fuel and oxidized substances (the best is fluid state) with a high pressure are charged in the two chambers separated from each other by a common partition wall in order to prevent the mixture of the two elements. When two separated chambers are filled, the partition wall therebetween does not exist (or a communicative hole appears on the partition) and in this position, the oxidized substance and fuel are mixed together. At high temperature and pressure, the reaction becomes more intense. It gives a higher heat energy and pressure so that the reaction spreads with a very quick speed (because of not expandeding immediately) and the products of the reaction have a very high temperature and pressure. After that, a valve on the reaction chamber opens so that the combustion products are discharged into the space having lower pressure. Here, the reacted products expand extremely fast so that the particles of mass of substances obtain a great acceleration. These particles are applied to a surface. This surface is the plane which forms into a reaction chamber. It is perpendicular to the direction of movement of the rockets or space shuttles. After the reaction the products are applied to the plane and their acceleration is decreased before discharging into the atmosphere to generate energy which serves as a pushing force for rockets or space shuttles.

Next, an explosive jet engine of straight cylinder type is described in detail.

The engine is constructed of round tube 44. Four plates of annular rings 47b are abutted against the inner face of the tube 44 and a space between the annular rings creates four slits 47e. The tube 44 is connected with round tube 47a of which the inner diameter is smaller than that of ring 47b. On the body of the tube 47a there are four slits 47f aligned with four slits 47e. The outside of the body of the tube 47a are the slits parallel to the center axle of the tube. In these slits are placed the coiled spring whose length is slightly longer than that of the tube. So when the spring is mounted, it will radially push some portions of the tube. On the body of the tube 47b are slits 55a and coiled springs 56a for radially pushing ring 47b. Three tubes 47a, 47b and 44 are connected to tube 49 having an inner diameter the same as the that of the tube 47 and the outer diameter the same as that of cylinder 44. Consequently, tubes 44a, 47b and 49 create a cylinder of three sections: section FG of which length is the same as cylinder 44, section GH whose length is the same as cylinder 47a and cylinder 47b, section HI whose length is the same as cylinder 49. Cylinder 49 is connected with a funnel shaped tube 53 whose diameter is gradually increased. These sections of cylinders are installed by bolts and their length is equal to the total length of the three sections of cylinder FG, GH and IH.

In cylinder tube 47b is placed piston 45 whose diameter is the same as cylinder 47b. On the piston are placed four flat rectangular plates 47c having the same length of piston 45 plus the length of cylinder 47. The end portion of piston 45 is integrally attached to a piston 45a whose diameter is equal to the inner diameter of cylinder 47a or cylinder 49. The length of piston 45a is about twice that of cylinder 47a; the bottom portion of the piston is connected to an end of spring 51. The other end of spring is abutted against bottom 52 of cylinder 44 on which is gas discharge hole 55a. When the piston is located in the cylinder, plates 47 are incorporated in the cylinder so as to form four separated chambers (whose volume is variable when the piston moves). When the cross section of the piston is in the position G and piston 45a moves from position G to go down to the bottom of the cylinder, the four chambers form a unique communicating chamber.

Each separated chamber on piston 45 is divided into two plates 47c having hole 45b at the bottom thereof. A communicative passage on piston 45 is connected with hole 45a to the surface of piston 45. Four holes 50a are provided on cylinder 44 and 47a so that when the piston is in the position, holes 50a and 45b are not aligned with each other because the body of piston 45 covers hole 50a. Holes 50a are connected to flow rate adjustment valves 50 in which there is an alternation between the adjustment valve for supplying fuel and the adjustment valve for supplying oxidized substance or compressed air. Consequently, each chamber for receiving the fuel is alternatively disposed by the oxidized chamber. When piston 45a moves from position G to the end side of the cylinder, piston 45a will move from the inner face of cylinder 47a and the reaction chamber is in communication with the surrounding chamber by the next funnel-shaped tube 53.

On cylinder 44 are mounted four heated spark plugs 44a which operate so that the engine is started easily. These four spark plugs are mounted near point G.

Operation of Explosive Jet Engine.

Fuel and oxidized substance in fluid or gas form generate high pressure on the outside of the engine and then they are introduced into valve 50. There is an alternation between two kinds of valves: a valve of fuel and a valve of oxidized substance or compressed air. When charging fuel and oxidized substance, four holes 50a are aligned with four holes 50b. The fuel flows through conducting passage 45b of piston 45 to enter into two fuel containing chambers joined by piston 45, the inner face of cylinder 44, plate 47c, the plane of cylinder 47a and small piston 45a. Oxidized substance or compressed air flows through the chamber of oxidized substance or the chamber of compressed air which is alternatively disposed.

Pressure of fuel or oxidized substance or compressed air (due to the inertia of the previous cycle or the affected external force when starting) slowly pushes the block of the piston down. However, since four plates 47c do not move from position G, oxidized substance (or compressed air) and fuel do not react with each other because they are separately received. When piston 45 goes slowly down and moves from position G, the charge of fuel and oxidized substance (or compressed air) is finished because hole 50a is completely covered by piston 45. At that time, the block of the piston continues to go down (because of the inertia of the previous cycle) until plates 47c move from position G, four chambers of fuel or oxidized substance (or compressed air) are communicative and form a single chamber. The fuel with a high temperature and pressure begins to react intensely to generate a high pressure. Because the top of piston 45a does not move from position G, fuel and oxidized substance react continually in the environment of high temperature and pressure so that the piston goes down until piston 45a leaves cylinder 47a and point G, the products of the reaction in a high temperature and pressure suddenly are discharged from the inner face of cylinder 47a and cylinder 49 to enter into the chamber having the next funnel-shaped tube 55. And in this chamber (its pressure is equal to that of the environment) they change their physical state of expansion extremely quickly so that particles move acceleration and eject with a very great acceleration. The walls 53, especially the wall of cylinder 49 hinders the motion of the particles in one direction in the process of expansion in order to decrease their acceleration. At the same time, the walls receive energy so as to jet the entire block of the engine to move on the same principle of a jet engine. However, this is the principle of explosive jet engine in which the jet force is significantly increased compared to a conventional jet engine by means of the differential pressure between the pressure of environment and that of the explosion chamber. On the other hand, an explosive jet engine is used to intermittently accelerate a space shuttle or rocket, so each cycle of the jet will terminate when the acceleration of rocket or space shuttle has been decreased. This causes the jet propulsion of the rocket (object having a little acceleration) or space shuttle to become more effective in comparison with a continual propulsion in order to create a great acceleration.

In addition, it is possible to connect funnel-shaped tube 53 with a turbine to change the expansion of the block of gas into energy of regular round motion.

Explosive Engine with a Partition:

The engine consists of two similar portions, each of them includes: cylindrical block 59, shaft 63 and yoke 63 are disposed therebetween. On the surface of the cylindrical block 59 there are radial slits 60. In these slits are placed the flat rectangular plates 61 and springs 61a for pushing flat plates 61 far from cylindrical block 59. Cylindrical block 59 with mounted rectangular plates 61 is placed on inner face of cylinder tube 58 which is the same length as cylindrical tube 61 and its diameter rate is about 10/8 compared with that of the cylindrical block 61 and is installed so that the external tangent of the cylindrical tube 59 contacts the inner face of the cylindrical tube 58 and the center axles of these cylindrical tube are aligned to each other.

Two similar portions then are installed closely and separated by a partition 70 on which is hole 70a. This hole 70a is located in the 7 o'clock position (according to the position of a watch needle) so that it is near the periphery of the cylindrical tube 59. A shaft with yoke 63a is disposed surrounding two columns 59 so that they rotate on the same shaft 63. Two tubes 66 are installed by bolt and springs on the inside of two cylindrical tubes so that the rotation of these cylindrical tubes is not blocked when the metal expands. Near the 7 o'clock position on the body of column 59, hole 65a and 65b is provided for each portion. The through hole 65a is connected to the fuel supplying tube to portion A, hole 65b—the tube of supplying oxidized substance (or compressed air) to portion B. Resistor 72 is installed at the 8 o'clock position of the body of column 58. Resistor 72 is connected to the electricity source and used when starting the engine.

On the body of the cylindrical tube 58 of each portion is a flat and elongated gas discharge hole extended from the position of 2 o'clock to the position of 5 o'clock. Consequently, cylindrical tubes 58, 59, the flat rectangular plates and partitions 70, 66 join together to form eight separated chambers whose volume varies when two cylindrical tubes rotate and the volume of each chamber gradually increases when shaft 63 rotates in the clockwise direction from the position of 6 o'clock to that of 12 o'clock. And the volume gradually decreases from the position of 12 o'clock to the position of 6 o'clock.

Operation of the Engine.

The cycle of the engine is started when a pair of chambers having two similar portions in the position of 6 o'clock and the flat plate of rectangle 61 is contacted with the inner face of the cylindrical tube 58 in that position. Flat plate 61 in that position cooperates with the next flat plate 61 in the position of 4.30 o'clock to form two separate parallel chambers. These chambers rotate in the clockwise direction (by means of the external force when starting or due to the inertia of the previous cycle) and go across hole 65a. When hole 65a is in the 7 o'clock position, fuel with the high pressure from hole 65a is conducted to the chamber of portion A which receives the fuel of the engine. From hole 65b oxidized substance or compressed air is conducted to the chamber of the portion B for receiving oxidized substance or compressed air. When the rear flat plate of the chamber goes across by ducts 65a and 65b, fuel or oxidized substance or compressed air with the high pressure in portion B is not received any more but is received in the next chamber. In the 8 o'clock position, the parallel chambers is communicate with the through hole 70a on partition 70, the fuel in part A and oxidized substance or compressed air in portion B of the two parallel chambers become communicative and mix together. In this position, resistor 72 (resistor for starting), and the fuel pressure and oxidized substance or compressed air react intensively in the high temperature environment. The high temperature causes the intensive expansion of the products so that this chamber expands and movs in the clockwise direction. When reaching the position of 2 o'clock, this chamber meets air discharge hole 67 which extends from the position of 2 o'clock to the position of 5 o'clock on the body of the cylindrical tube 58. This is a period of generating the mechanical power for the engine and block of air discharged in the environment is moved to the position of 6 o'clock and starts a new cycle of this chamber.

Each cycle of the engine is disposed in series by the next chambers. This thing creates a rotary force for shaft 63 and transfers the energy of rotation to the outside through shaft 63. When the engine is operated in a certain period, there is an accumulation of heat so that resistor 72 stops. The accumulated sufficient temperatures then make the oxidized substance (or compressed air) react by themselves when two parallel chambers go across the hole 70a on partition 70.

The engine operates with a great power and obtains an acceleration by adjusting fuel supply, oxidized substance or compressed air. Because the engine doesn't generate any pressure for oxidized substance, air and fuel (executed on in the outside) the engine operates suitably for fast acceleration used for race automobiles, boats, or express boats . . . .

Creating air or oxidized substance with a high pressure from the outside, especially oxidized substance and fuel reacted in the fluid state, cause a high reaction temperature and the process of the expansion of reacted products from a heavy density generates a very great mechanical power. Here, the rate of volume expansion of the gas block after expansion and the products before the reaction is significantly high in comparison with a conventional combustion engine in which fuel, oxidized substance, or air before the reaction have a lower density.

1. An engine for generating mechanical energy which is capable of changing the physical state of fluid or solid of low boiling temperature or their mixtures into the gas state extremely quickly so as to generate mechanical energy, comprising: at least a chamber or a bulb which contacts a heat source of high temperature to supply the heat energy to fluid or solid of low boiling temperature in order for them to obtain a high temperature and pressure in said chamber or bulb that is called the primary heating chamber and a heat supplying source is called the primary heat supplying source, at least one other chamber which is called a secondary heating chamber and a heat source which contacts this chamber so as to supply heat energy to fluid or solid of low boiling temperature when they are contained in said chamber, the heat source is called the secondary-heat supplying source, in which at least a formed hole is communicated with a duct, this duct is connected to said primary heating chamber so that the fluid or solid heated of low boiling temperature passes through the hole to said secondary heating chamber, in which a pressure sensor or an elastic screen or a piston located in a cylinder is provided, the piston or screen is moved under the pressure varied in said secondary heating chamber, at least a discharge valve is provided on a wall of said chamber, heated gas with a high pressure from the primary chamber after being introduced in secondary chamber is heated again to a high enough pressure, the sensor receives and outputs a signal to open the discharge valve or to move the screen or the piston and also causes the discharge valve to open, the fluid or solid of low boiling temperature and a very high temperature suddenly escapes via a hole in the discharge valve in order to enter into an other chamber in which the pressure is so much lower in comparison with that at which they have just been discharged, and at least a chamber into which the fluid or solid of low boiling temperature with a high temperature is discharged, in said chamber the fluid or solid will quickly change its physical state and generate mechanical energy, said chamber is called a physical state changing chamber for fluid or solid of low boiling temperature.

2. An engine for generating mechanical energy according to claim 1, wherein said secondary heating chamber containing fluid or solid of low boiling temperature which is conducted to a hole of said secondary heating chamber in every batch, said hole is closed while the fluid or solid of low boiling temperature is heated, or fluid can be interruptedly pumped by a high pressure pump.

3. An engine for generating mechanical energy according to claim 1, wherein said fluid is water or liquid nitrogen or oxygen and said solid is CO₂ powder.

4. An engine for generating mechanical energy according to claim 1, wherein said secondary heating chamber is insulated by a foam wall to prevent escape of the heat energy.

5. An engine for generating mechanical energy according to claim 1, wherein at least a turbine is installed in said physical state changing chamber in which the energy of the change of physical state is changed into energy to rotate the turbine, or at least a piston, a connecting rod and a fly wheel are installed in said chamber so that the energy of the change of physical state is changed into energy to rotate the axle of fly wheel.

6. An engine for generating mechanical energy according to claim 1, wherein said primary and secondary heat supplying sources used include a heating resistor or an AC coil for generating varied magnetic field by heating the magnetic material of the engine or microwave or laser beam or flame or electric spark, or liquid fluid such as melting metal, melting alkali (melted from the outside).

7. An engine for generating mechanical energy according to claim 1, wherein the engine comprising: at least a big piston on top of this, another piston of which the diameter is smaller than that of said big piston is connected, the center axis of the two pistons are parallel, a unit of said two pistons are located in a cylinder which consists of a big cylinder having the inner diameter equal to that of the big piston and a small cylinder connected with a big one so that it can be placed on the inner face of the big cylinder in a position near a small cylinder (called the upper position), a small piston is placed in a small cylinder, when said small piston is in the lower position (called the lower position), said big piston is still placed on the inner face of the big cylinder but said small piston is moved therefrom, at least a hole is formed on the perimeter surface of the body of the big piston at position near to the end of it, said hole is provided with a passage from the inside of the big piston to the end surface of it, at least one hole for feeding the fluid or solid of low boiling temperature is heated from said secondary heating chamber, when said big piston is in the upper position said hole of the body of said big piston is aligned with that of the body of said big cylinder, when said big piston is removed from the upper position to advance to its lower position the body of the big piston will cover the hole which supplies the fluid or solid of low boiling temperature from said primary heating chamber whereby, the fluid or solid of low boiling temperature heated in the primary heating chamber is conducted to a flow rate adjust valve and via the hole of the big cylinder, when said big piston is in the upper position, the hole on the body of the big cylinder is aligned with that of the big piston, the fluid or solid or their mixtures enter via said two holes of said big piston and then flows to a chamber foamed by the surface of the big piston, the inner face of the big cylinder, the end surface of the big cylinder and small piston, at this chamber, the fluid or solid of low boiling temperature is heated in the primary heating chamber contacts the heated wall of cylinder by the primary heat source so that they are heated again, expanded and thus the piston is pushed toward the lower position, when big piston is started to move the hole on the body of the big piston is covered by the body of the big piston, when big piston advances the lower position, said small piston is moved from the inner face of the small cylinder and block of fluid or solid of low boiling temperature in the secondary heating chamber is suddenly discharged via the physical state changing chamber and the inner face of the small cylinder, since its pressure is so much lower than that of the secondary heating chamber, the block is quickly changed from the fluid to solid form or from concentrated vapor to gas form with a high dispersion, the changing of physical state of this block generates mechanical energy, when the block is introduced via the physical state changing chamber to escape into the environment, the pressure in the secondary heating chamber also is decreased and the springs (or fly wheel through connecting rod) push said big piston to the upper position to finish a cycle of the engine, and the next cycle also is operated in the same way.

8. An engine for generating mechanical energy which is capable of changing the physical state from fluid to solid forms or from concentrated vapor to gas form extremely quickly to generate mechanical energy, comprising: at least a chamber or a bulb which contacts a heat source of high temperature to supply the heat energy to fluid or solid of low boiling temperature so as to obtain a high temperature and pressure in said chamber or bulb, said chamber is called a primary heating chamber and a heat supplying source is called the primary heat supplying source, at least a cylinder block on which a shaft is disposed in the middle of the center axle of the block and three rectangular slits are formed on the periphery of the body of the cylindrical block and are located parallel to the center axle of the cylindrical block and are deeply disposed in the radial direction of the body of the cylindrical block toward its center axle, three flat plates of which the length and the depth are the same as that of the flat slits, at least a spring is disposed at the lower side of each flat plate to push the flat plates far from the center of the block, said block with installed flat slits and plates is placed in a cylindrical tube of which the length is the same as that of the cylindrical block so that the two outer surfaces of the block are aligned with those of the cylindrical tube, the two cylindrical blocks and the cylindrical tube have the parallel center axles and the external tangent of the cylindrical block contacts the inner face of the cylindrical tube and two outer surfaces of the cylindrical block and cylindrical tube are attached to two flat plates through which the shaft of the tube pierces, the cylindrical block, flat plates, the inside of the tube and the two surfaces of the outer flat plates are cooperated to form chambers of which the volume is variable when the cylindrical block rotates around its axle in the inner face of the tube, and the chambers have the smallest volume when they are near the contacting line between the periphery of the cylindrical block and the inner face of the cylindrical tube and having the greatest volume when chambers are in the symmetrical position through the center on the contacting line between the block and the tube, in the cross-section perpendicular to the center axle of the block and the tube is a circular and contact point between the cylindrical block and the tube in the position of 6 o'clock (position of a watch needle) and the opposite position located via the center of the cylindrical block is the position of 12 o'clock, at least one through hole is formed on the body of the tube at the 7 o'clock position for conducting the fluid or solid of low boiling temperature to the chamber with variable volume, on the body of the tube at the 8 o'clock position is disposed a resistance for heating the fluid or solid of low boiling temperature in the chamber of variable volume when it is moved through this position, a hole is formed on the body of the tube from the position of 2 o'clock to 5 o'clock so as to gas is discharged into the environment, whereby fluid or solid of low boiling temperature heated in secondary heating chamber passes via a hole of the cylinder in the 7 o'clock position to enter into the chamber of variable volume, the impetus of the previous cycle or the external force when starting pushes the chamber to rotate in the clockwise direction (the direction of the clock needle), when the chamber of variable volume moves to the 7 o'clock position, the fluid or solid of low boiling temperature stops going to this chamber, when the chamber moves from the positions of 8 to 9 o'clock, the fluid or solid of low boiling temperature in this chamber is heated and expanded quickly so that the volume of this chamber is increased, when being pushed in the clockwise direction the chamber of variable volume generates mechanical energy to rotate the cylindrical block and its axle, the rotation continues until it can receive the greatest volume in the position of 12 o'clock, after that the rotary impetus causes the chamber of variable volume to move to position from the 2 o'clock to 5 o'clock position, the block of gas in this chamber escapes in the environment and the chamber continues to move to the position of 2 o'clock in order to start a new cycle.

9. An engine for generating mechanical energy according to claim 8, wherein at least one turbine is installed in the hole of the body of the tube so that the gas discharged is changed into the energy to rotate the turbine, or it is possible to install cylinder and piston, connecting rod, and fly wheel in order to change the energy of the process of changing physical state in this chamber into energy for rotating the axle of fly wheel.

10. An engine for generating mechanical energy in which fuel or mixtures containing fuel such as a mixture of alcohol and water and oxidized substance (like the air) can react together when they are in fluid or solid form or they have a heavy density so as to create a high temperature for the reaction and the combustible product is suddenly expanded to generate a great mechanical energy, said engine comprising: at least a small chamber which receives and contains the fuel of its mixtures called the fuel containing chamber, in which at least a hole is formed for receiving fuel or its mixtures, at least a small chamber which receives and contains the oxidized substance or its mixture called the oxidized substance containing chamber, at least a common partition disposed between two chambers on which at least a hole or a space is formed, a big chamber includes two small chambers and a partition wall which can move so that they obtain the two states: in the first state, the two chambers are separated by the partition wall, and in the second state, the two chambers are communicated by said hole or space on the partition, the volume of the two chambers is or is not variable, in the position where the two chambers are separated, at least a hole is formed in each chamber so that the fuel or its mixture is received in one chamber and the oxidized substance or its mixture is received in other chamber, after that two holes are closed by the movement of the two chambers or partition relative to the big chamber, the movement is performed by the inertia of the previous cycle or by the external force applied during starting, two chambers are moved relative to the partition to a position in which a hole or a space is formed so that two holes are communicated with each other, at this position the fuel or its mixture and oxidized substance or its mixture are mixed and reacted together by a high temperature accumulated in the two chambers and partition of the previous cycle or by the heating of spark plug upon starting, After the reaction, the chamber of variable volume reacts and generates the heat so that the products in the two communicated chambers are expanded and generated the mechanical power by which two small chambers are moved in the big chamber in order to obtain the greatest volume, then by means of inertia two small chambers are moved in the big chamber toward the position at which a discharge hole is formed on the body of the big chamber for discharging the reacted products in the atmosphere, while in the chamber of invariable volume, the inertia continues to make two small chambers move in the big chamber to a position where they meet the body of the big chamber having a discharge hole for dispersing the products to the outside, then the products create a reaction force so that the two small chambers move in the big chamber, after the product escapes, the pressure in the chamber will be decreased, by inertia the two chambers move toward the initial position in order to begin a new cycle.

11. An engine for generating mechanical energy according to claim 10, wherein inside the discharge hole of the product is mounted a cone tube of which a small portion is connected with the discharge hole and the big portion is a long tube section so as to react products entered therein and very quickly change the physical state thereof, since the cone tube with a cylinder section is communicated with the atmosphere, the pressure therein is significantly lower than that of the big chamber, the product changes the physical state extremely quickly from fluid, solid, vapor with a thick density to gas form and ejects to form a pushing force for the engine, and this is an explosive jet engine with a partition.

12. An engine for generating mechanical energy according to claim 10, wherein inside the discharge hole for the reacted product is mounted a cone tube of which small portion is connected with the discharge hole and the big portion is a long tube section in which a piston is connected to a connecting rod and fly wheel, or turbine is disposed so that the reacted products discharged therein, the products change the physical state extremely quickly from fluid, solid, vapor with a thick density to gas form, the expansion of the block of gas applies to the piston or turbine so that this expansion is changed into mechanical power to rotate the fly wheel or turbine, the engine is called an explosive engine with partition and explosive engine with turbine-partition.

13. An engine for generating mechanical energy according to claim 10, wherein at least fluid substance or solid having a low boiling temperature such as liquid water, liquid nitrogen, or CO₂ solid powder is conducted into the big chamber or cone tube in order to increase the expansive products and at the same time to adjust the temperature of engine.

14. An engine for generating mechanical energy according to claim 10, wherein fluid or solid having the low boiling temperature such as liquid water, liquid nitrogen, or CO₂ solid powder is heated in the outer primary heating chamber.

15. An engine for generating mechanical energy according to claim 10, wherein the outer case of the engine is coated by a layer of insulation foam in order to limit the escape of the heat energy of engine.

16. An engine for generating mechanical energy according to claim 1, wherein an explosive jet engine of piston partition type includes: at least two small chambers formed by a common partition are disposed in the top of a big piston of cylinder shape, the direction of the partition is parallel to the center axle of the big piston which is installed with the partition in a big cylinder of which the diameter is the same as that of the big piston, when the big piston at the position of the top of the big cylinder, the big piston, a common partition and the top cross section of the big cylinder form two separated chambers, where the first small chamber receives fuel or its mixture from a hole on the body of the big cylinder or a valve located on the top side of the big cylinder, the second small chamber receives oxidized substance or its mixture from a hole on the body of the big cylinder or from a valve located at the top side of the big cylinder, after two chambers receive fuel and substances and their mixtures, two holes are covered by the movement of the big piston to the bottom of the big cylinder (by the inertia of the two previous, cycles or the affection of force when starting) and two holes supplying fuel or oxidized substance or its mixture and the two valves at the top side of the big cylinder are closed by the movement of the two chambers via driving structure incorporated in the movement of the big piston, the movement of the two chambers also gives a space communicated there between so that the fuel and oxidized substance or its mixture are mixed together to react suddenly by the high temperature accumulated in the piston-cylinder from the previous cycle or a heated spark plug, the temperature of the reaction makes the volume in big common chamber expand and push the big and small pistons to move at the bottom position of the big cylinder, at which a discharge hole is disposed on the body of the cylinder, a common chamber has a high temperature so that the temperature is transmitted to the next chamber, in the next chamber there is a tube connected to a discharge hole on the body of the big cylinder, in the next chamber these substances are changed extremely quickly into gas and ejected in order to create an reaction force of propulsion for the engine, the next chamber is called chamber of changing the physical state, when the block escapes in the chamber of change of physical state, the pressure in the big common chamber is decreased, the piston continues to move to the top side of the cylinder by the inertia thereof and starts the next cycle.

17. An engine for generating mechanical energy according to claim 16, wherein a small piston of which the diameter is smaller than that of the big piston is disposed between two partitions on the top of the big piston and is joined to the big piston, and its direction is parallel to the center axle of the big cylinder and its length is greater that that of a common partition, disposed on the top of the big cylinder is a small cylinder connected to the top of the big cylinder, its direction is parallel to that of the big cylinder and placed in the position so that when the big piston is at the top of the big cylinder, the small piston is in the inner face of the small cylinder, when a big piston is at the top of the cylinder, the big piston, partition, and the inner face of the big cylinder form two separate chambers, when the big piston is at the bottom position of the big cylinder, the top of the big piston, the inner face of and the top of the big cylinder form a common chamber, that means two small cylinders are communicated and small piston is moved away from the small cylinder when the big piston is at the upper position, the first chamber receives fuel or its mixture through a hole on the body of the big cylinder or a valve on the top of the big cylinder, the second chamber receives oxidized substance or its mixture through a hole on the body of the big cylinder or a valve on the top of the big cylinder, then two holes are closed by the movement of the big piston to the bottom of the big cylinder and the body of the big piston covers the two holes for supplying fuel to the body of the big cylinder or two valves on the top of the big cylinder are also closed by the movement of the two chambers via driving structure combined with the movement of the big piston, two chambers are slowly moved to the bottom position of the big cylinder, on a common partition there is a space between the two chambers, so fuel or its mixture and oxidized substance or its mixture is suddenly reacted by the temperature accumulated in the piston-cylinder from the previous cycle or the heated spark plug when starting, the temperature of the reaction makes the volume in the big common chamber expand and push the big piston to the bottom position of the big cylinder, here the small piston is moved away from the inner face of the small cylinder, in this position substances meet at a discharge hole in the inner face of the small cylinder and they escape into the next chamber which is a cylindrical tube installed on the outer surface of the small cylinder, in the next chamber these substances are changed into gas and are ejected in order to create a reaction force of propulsion for the engine of the next chamber, the next chamber is called chamber of transfer of physical state, when the substances escape into the chamber of transfer of physical state, the pressure in the common chamber is decreased, the piston continues to move to the top side of the cylinder by the inertia and starts a new cycle.

18. An engine for generating mechanical energy according to claim 9, further comprising:
at least two similar portions in which the first portion is used to receive and hold fuel or its mixtures, the second portion is used to receive and hold an oxidized substance or its mixture,
a small cylindrical block on which a shaft is disposed in the middle of its center, at least four flat rectangular slits of which the length is the same as that of the small cylindrical block and the direction of these slits is parallel to the center axle of the cylindrical block, placed in the flat slits a flat rectangular plates of which length, width, and depth are approximate to those of flat rectangular slits, at least a spring is located in the bottom of each flat plate to radially push the flat plate far away,
a big cylindrical tube of which the diameter and length is either greater or the same as that of the small cylindrical block, respectively,
a cylindrical block with flat plates installed in flat slits put in the inner face of the big cylindrical tube so that the cylindrical block is aligned with the big cylindrical tube and their center axle is parallel to one other,
two portions are abutted against a common partition so that their two circular sections are aligned, and the two outer surfaces are closely installed by two flat plates, a shaft goes through these two flat plates, the cylindrical block, partition, and the two long pins are provided on the shaft; so that the big cylindrical blocks are rotated synchronically,
the cylindrical block, flat plates, the inner face of the big cylindrical tube and two flat plates are incorporated into chambers having a variable volume, the volume of the chambers become the smallest when the chambers are near the tangent of the cylindrical block and the inner face of the big cylindrical tube, the volume becomes the greatest when the chambers are in symmetrical position through the center the cylindrical block and the tangent
at the cross section perpendicular to the center of the cylindrical block and cylindrical tube, the contact point between the cylindrical block and cylindrical tube is the position of 6 o'clock (according to the position of needles on a watch) the opposite position on the inner face of the big cylindrical tube is the position of 12 o'clock,
in cross section of the cylindrical tube at the 8 o'clock position, on the body of the first portion there is a hole for receiving fuel or its mixture, on the body of the second portion there is a hole for receiving oxidized substance or its mixture, on a common partition at the position of 10 o'clock there is a hole or a space, in a position from 11 o'clock to 12 o'clock on the body of the big cylindrical tube of the two portions are two gas discharge holes, to which is/are attached one or two cylindrical tube(s) or a funnel-shared tube (a) so that the direction of the tube(s) is parallel to the tangent of a circular surface of the big cylindrical tube in counterclockwise direction on the body of the big cylindrical tube there are at least two flat holes extending from the position of 2 o'clock to 5 o'clock in other to allow the excess gas to escape,
whereby, when two portions have two chambers of variable volume are simultaneously in the position of 6 o'clock, the block of the cylindrical tube rotates in the clockwise or counterclockwise directions (if the members of the engine are designed vice-versa) (the block of the cylindrical tube is rotated by the inertia of the previous cycle or the external force affected when starting) and the volume of the chamber of variable volume is increased, when the small cylindrical block is moved to the 8 o'clock position, the chamber of variable volume on the first portion receives fuel or its mixture through a hole on the body of the cylindrical tube in 8 o'clock position, the small cylindrical block continuously rotates to push the chamber toward position of 10 o'clock in order to meet a communicative hole or a space on a common partition, in this position, fuel or its mixture and oxidized substance or its mixture of the two chambers react and generate heat and thereby volume of the chamber of variable volume is increased, at the same time the chamber of variable volume is push toward position of 11 o'clock, in this position, the products in the two chambers of variable volume are discharged in order to put the chambered toward position of 2 o'clock, in which the excess gas with low pressure is not fully discharged and the chamber is continuously to position of 6 o'clock and the next cycle is stated, the products discharged in discharge bole or cylindrical tube are very quickly changed the physical state thereof, where the pressure is lower than that of the chamber of variable volume when it is in the positions from 11 o'clock to 12 o'clock, after the expansion, they are ejected in the outer environment in order to generate jet force for the engine.

19. An engine for generating mechanical energy according to claim 18, wherein the fuel or its mixture and oxidized substance or its mixture are heated in order to obtain a high temperature and a high pressure from the outer of the engine before conducted to the chambers of variable volume of the engine.

20. An engine for generating mechanical energy according to claim 9 further comprising:
at least two similar portions in which the first portion used to receive and hold fuel or its mixture, the second portion used to receive and hold oxidized substance or its mixture, each of portions including:
a small cylindrical block on which there is a shaft in the middle of its center, on the perimeter of the block are formed four flat rectangular slits of which length is the same as that of the small cylindrical lock and the direction of slits is parallel with the center axle of the cylindrical bloc in flat slits are placed flat rectangular plates of which length, width, and depth are approximate to those of flat rectangular slits, at the bottom of each flat plates axe disposed the springs to radially push the flat plates away from,
a big cylindrical tube of which diameter and length is greater than and is the same as those of the cylindrical block, respectively,
the cylindrical block with flat slits installed by flat plates is put in the inner face of big cylindrical tube so that the cylindrical block is aligned with the big cylindrical tube and their center axle is parallel with one other,
two portions are abutted against a common partition so that two circular cross sections are aligned, and two outer cross sections are closely installed by two flat plates, a shaft is pierced through two flat plates, the cylindrical block, partition, two long pins are provided on the shaft to synchronically rotate the big cylindrical blocks,
consequently, the cylindrical block, flat plates, the inner face of big cylindrical tube and two external planes are incorporated into a chamber having a variable volume, the volume of the chambers become the smallest when the chambers are near the tangent of the cylindrical block and the inner face of big cylindrical tube, the volume becomes the greatest when the chambers are symmetrical position through the center the cylindrical block and the tangent,
in cross section perpendicular with the center the cylindrical block and cylindrical tube, the contact point between the cylindrical block and cylindrical tube is called a position of 6 o'clock (according to the positions of needles on a watch), the opposite position in the inner face of the big cylindrical tube is position of 12 o'clock,
in cross section big cylindrical tube of 7 o'clock position, on the body of the big cylindrical tube of the first portion there is a hole for receiving fuel or its mixture, on the body of the second portion there is a hole for receiving oxidized substance or its mixture, on a common partition of 8 o'clock position there is a hole or a space, in the positions from 1 o'clock to 5 o'clock, on the, body of big cylindrical tube of the two portions are formed two gas discharge holes so that gas is discharged in the atmosphere after it is expanded in the chamber of variable volume,
whereby, when two portions having two chambers of variable volume is simultaneously in the position of 6 o'clock, the block of the cylindrical tube rotates in the clockwise or counterclockwise directions if the members of the engine designed vice-versa (block of the cylindrical tube is rotated by the inertia of the previous cycle or the external force affected when starting) and the volume of the chamber of variable volume is increased, when the small cylindrical block is moved to 7 o'clock position, the chamber of variable volume on the first portion receives fuel or its mixture through a hole on the body of the cylindrical tube in 7 o'clock position, the small cylindrical block is continuously rotates to push the chamber toward 8 o'clock position in order to meet a communicative hole or a space on a common partition, in this position the fuel or its mixture and oxidized substance or its mixture of the two chambers react and generate heat and the volume of the chamber of variable volume is expanded, at the same time the chamber of variable volume is pushed toward position of 12 o'clock of the greatest volume, the process of expansion of the volume of chamber from 8 o'clock position to 12 o'clock of engine generates mechanical power, after that the cylindrical is continuously rotated to position of 1 o'clock in order to meet an discharge hole on the body of big cylindrical tube, the hole is extended from position of 1 o'clock to 5 o'clock, the excess products is completely discharged a the chamber of volume is moved go to position of 6 o'clock in order to start next cycle.
